(19) United States
(12) Patent Application Publication
(10) Pub. No.: US 2008/0018878 A1
(43) Pub. Date: Jan. 24, 2008

(54) Optical device and electronic device

(75) Inventors: Kazuhiro Mizuo, Nara (JP); Shinya Kawanishi, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/826,175

(22) Filed: Jul. 12, 2007

(30) Foreign Application Priority Data
Jul. 21, 2006 (JP) 2006-199704

(51) Int. Cl. G03B 13/20; G01C 3/02; G02B 7/02

(52) U.S. Cl. 356/3.01; 359/808

(57) ABSTRACT

An optical device according to an embodiment of the present invention is an optical device including a lens structure in which a lens portion is injection molded integrally with a skirt portion extending from the edge of the lens portion, and a housing that supports this lens structure. The skirt portion has a molding gate receiving portion corresponding to a molding gate for injection molding, and the thickness of the edge<the thickness of the molding gate receiving portion<the thickness of the lens portion is satisfied.

This application claims priority under 35 U.S.C. §119(a) on Japanese Patent Application 2006-199704 filed in Japan on Jul. 21, 2006, and the contents thereof are incorporated herein by reference in their entirety.

### BACKGROUND OF THE INVENTION

1. Field of the Invention

The present invention relates to an optical device and an electronic device in which an injection molded lens structure is supported in a housing.

2. Description of the Related Art

A method has been proposed in the past for making a lens by an injection molding method such as transfer method. In the manufacture of a lens by this manufacturing method, enough time has to be allowed for cooling in the molding step to achieve high performance. Examples of applications of optical devices in which such lenses are used include infrared range-finding sensors, reflection type infrared sensors, and applications in which two or more of these sensors are combined.

For example, JP 2000-79629A is known as a conventional method for injection compression molding. With the injection compression molding method described in this patent, even when the opening space of the gate and the compression allowance in the cavity are set according to the lens shape (such as a plus lens or minus lens) or according to the lens power, since the gate opening is closed upon completion of the injection of the molten resin, the molten resin can be prevented from flowing back from the gate to the resin flow path during cooling.

Therefore, the opening space of the gate and the compression allowance in the cavity can be freely set according to the lens shape, without having to find a way to prevent the molten resin from flowing back from the gate to the resin flow path. For example, in the molding of a plus lens, the gate opening shape can be set small so as to keep the occurrence of “sink marks” to a minimum.

With this molding method, however, the molding conditions and the structure and operation of the mold are more complicated, the mold is larger, and there are various limitations on the molding apparatus and so forth. This structural complexity also hampers efforts at reducing cost.

In other words, with a lens structure produced by a conventional manufacturing method, it is difficult to mold a lens that is thick, and since there is only a narrow space around the lens for injecting the resin, resistance is encountered in the injection of the molding resin, which is a problem in that the molding resin does not flow smoothly to the lens.

Reducing the size and increasing the performance of an optical device requires the use of a lens (lens structure) having short focus and wide numerical aperture characteristics. To achieve short focus and wide numerical aperture characteristics, a lens that is thick and has a shape having a broad surface area is required.

Nevertheless, with a conventional lens production method involving injection molding in which a synthetic resin is used, when an attempt is made to produce a lens having a broad surface area and a small curvature, the joined portion between the lens end portion and the skirt portion around the lens (that is, the edge) ends up being extremely thin, and this impairs fluidity when the molding resin injected from the molding gate flows past the skirt portion toward the main body of the lens.

If the fluidity of the molding resin is impaired, pressure is not applied to the mold space where the lens is being molded, resulting in lens sink marks, incomplete filling, and so forth, and this makes high-precision lens molding impossible. One possible way to deal with this is to reduce the lens surface area and increase the thickness of the joined portion, but reducing the lens surface area decreases the numerical aperture of the lens (lens diameter/focal length), and this diminishes the performance of the completed product as an optical device.

Also, when a lens with a large surface area is produced, the larger size of the lens makes it more difficult to incorporate a positioning structure for fixing the positional relationship between the lens and the light emitting element or light receiving element, and this makes the assembly work more difficult in producing a high-quality optical device.

That is, the problems discussed above must be solved to produce a lens that is thick, has a large diameter, and has a small curvature.

### SUMMARY OF THE INVENTION

The present invention was conceived in light of this situation, and it is an object of the present invention to provide an optical device in which the thickness of a molding gate receiving portion corresponding to the molding gate used for injection molding is greater than the edge thickness, and the thickness of the molding gate receiving portion is less than the thickness of the lens portion, thereby providing a lens structure having a lens portion that is thick and has a broad surface area.

It is another object to provide an electronic device in which the optical device according to the present invention is mounted, so that short focus and wide numerical aperture characteristics are obtained, and therefore an electronic device that is smaller and has higher functionality can be obtained.

The optical device according to the present invention is an optical device comprising a lens structure in which a lens portion is injection molded integrally with a skirt portion extending from the edge of the lens portion, and a housing that supports the lens structure, wherein the skirt portion has a molding gate receiving portion corresponding to a molding gate for injection molding, and the thickness of the edge<the thickness of the molding gate receiving portion<the thickness of the lens portion is satisfied.

With this constitution, it is possible to reduce resistance to the flow of the synthetic resin (molding resin) supplied from the molding gate receiving portion to the skirt portion and the lens portion, so good fluidity of the molding resin to the skirt portion and the lens portion is ensured, and the resin flows into the mold more smoothly and stably. Therefore, there is no loss of fluidity of the synthetic resin, the skirt portion and lens portion can be filled and molded smoothly and with good fluidity, stable injection molding can be performed at a high yield, and the desired lens structure can be obtained. In other words, it is possible to obtain a lens structure equipped with a lens portion that is thick and has a broad surface area, and an optical device equipped with a lens structure having short focus and wide numerical aperture can be obtained.

Also, in the optical device according to the present invention, the thickness of the edge may be about 0.2 to 0.5 mm.

With this constitution it is possible to form a lens structure at high precision and a good yield.

Also, in the optical device according to the present invention, the molding gate receiving portion may have two plane faces disposed parallel to a direction intersecting the optical axis direction of the lens portion.

With this constitution, the flow of the molding resin from the molding gate to the skirt portion and lens portion is stabilized and good fluidity can be ensured, so stable injection molding with a good yield can be achieved. Also, the mold structure is simplified and the product can be manufactured more easily.

Also, in the optical device according to the present invention, the lens portion may have an aspherical shape.

With this constitution, it is possible to obtain a compact, lightweight optical device equipped with a lens portion that produces no aberration.

Also, in the optical device according to the present invention, a printed substrate on which optical semiconductor elements are mounted may be inserted in the housing and across from the lens structure, and the printed substrate may be screwed to a substrate fixing column formed on the inner bottom face of the housing.

With this constitution, the optical semiconductor elements and the lens structure can be easily positioned and fixed across from one another.

Also, in the optical device according to the present invention, the printed substrate may be configured so as to abut an anti-rotation portion formed on an inner side face of the housing.

With this constitution, rotation of the printed substrate caused by screwing it in place can be effectively prevented, and the positioning of the optical semiconductor elements and the lens structure can be carried out at high precision, so a high-precision optical device can be obtained.

Also, in the optical device according to the present invention, the anti-rotation portion may be in the form of a semicircular column.

With this constitution, the printed substrate can be inserted into the housing easily and at high precision.

Also, in the optical device according to the present invention, the anti-rotation portion may have a slanted portion for inserting the printed substrate.

With this constitution, the printed substrate can be easily and reliably inserted into the housing.

Also, in the optical device according to the present invention, the substrate fixing column may be supported by a plurality of reinforcing plates.

With this constitution, the substrate fixing column is securely supported to ensure adequate strength, and the optical semiconductor elements can also be shielded from surrounding light, so an optical device of higher reliability can be obtained. Also, when the housing is injection molded, the occurrence of sink marks can be prevented, making it possible to obtain a housing free of distortion, and allowing an optical device to be obtained at a high yield.

Also, in the optical device according to the present invention, the lens structure and the housing may be molded integrally.

With this constitution, it is possible to obtain an optical device with a simplified manufacturing process.

Also, in the optical device according to the present invention, the optical semiconductor elements may be a semiconductor light-emitting element and a semiconductor light-receiving element mounted apart from each other on the printed substrate, and a light emission lens structure disposed across from the semiconductor light-emitting element and a light reception lens structure disposed across from the semiconductor light-receiving element may be disposed as the lens structure.

With this constitution, it is possible to obtain an optical device having a function corresponding to that of a combination of a semiconductor light-emitting element and a semiconductor light-receiving element.

Also, in the optical device according to the present invention, the device may be a range-finding device that measures the distance to a ranging object by irradiating the ranging object with the light from the semiconductor light-emitting element through the light emission lens structure, and receiving with the semiconductor light-receiving element the light reflected by the ranging object, through the light reception lens structure.

With this constitution, a range-finding device of reduced size and that is capable of measuring distance at high precision can be obtained.

Also, the electronic device according to the present invention is an electronic device in which an optical device is mounted, wherein the optical device is the optical device according to the present invention.

With this constitution, it is possible to obtain an electronic device of reduced size and higher functionality by way of having short focus and wide numerical aperture characteristics.

### BRIEF DESCRIPTION OF THE DRAWINGS

FIG. 1 is a plan view showing the surface of a lens structure applied to an optical device according to an embodiment of the present invention.

FIG. 2 is a see-through cross section, viewed along the B-B line in FIG. 1.

FIG. 3 is a plan view showing the back side of an optical device according to an embodiment of the present invention, in a state in which a lens structure is disposed in the housing of the optical device.

FIG. 4 is a plan view showing the rear face of a printed substrate inserted inside the housing of an optical device according to an embodiment of the present invention.

FIG. 5 is a plan view showing the back side of an optical device according to an embodiment of the present invention, in which a printed substrate is inserted inside the housing of the optical device.

FIG. 6 is a cross section, viewed along the X-X line in FIG. 5.

FIG. 7 is a cross section, viewed along the Y-Y line in FIG. 5.

FIG. 8 is a diagram illustrating how an optical device according to an embodiment of the present invention is operated as a range-finding device to measure the distance to a ranging object.

### DESCRIPTION OF THE PREFERRED EMBODIMENTS

An embodiment of the present invention will now be described through reference to the drawings.

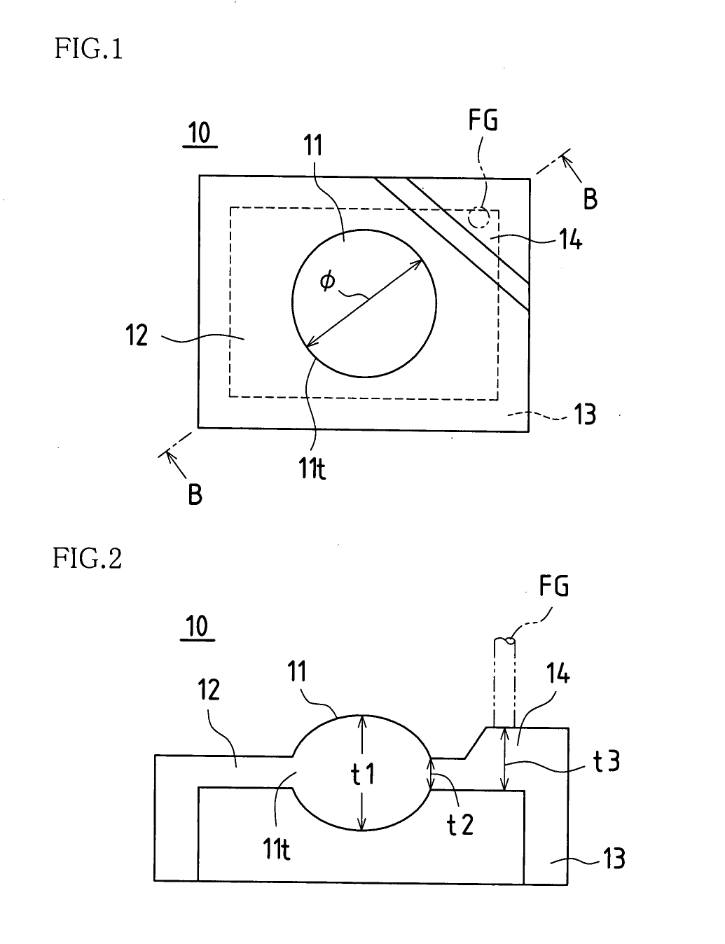

FIG. 1 is a plan view showing the surface of a lens structure applied to an optical device according to an embodiment of the present invention, and FIG. 2 is a see-through cross section, viewed along the B-B line in FIG. 1. The hatching of the cross section is omitted in FIG. 2.

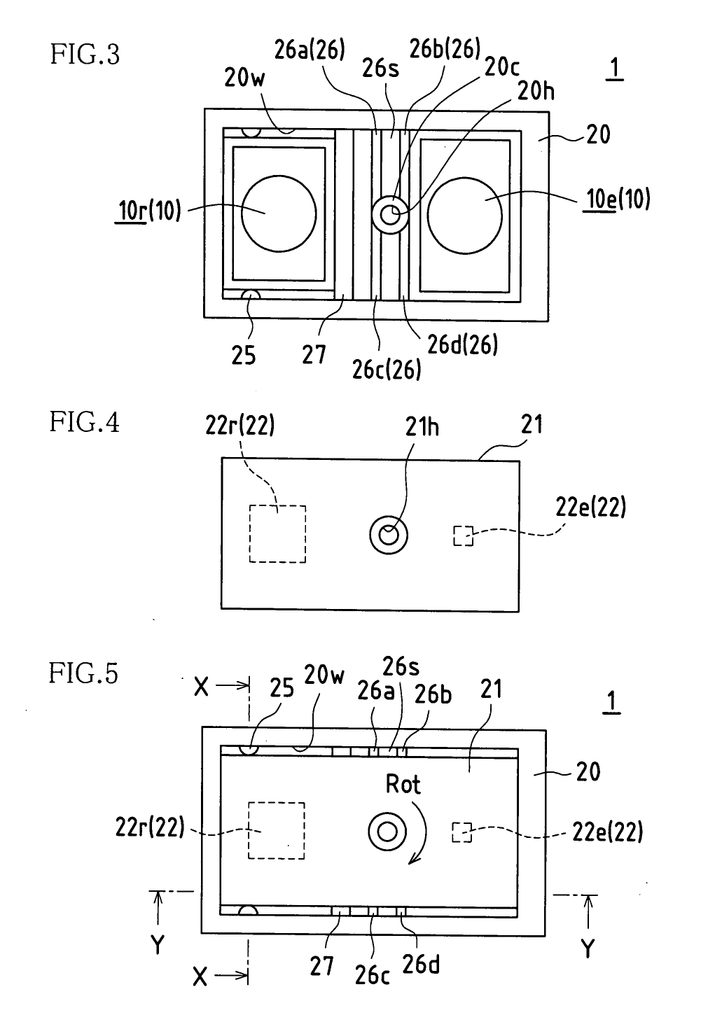

The lens structure 10 applied to the optical device 1 (see FIGS. 3 to 5) according to this embodiment has a lens portion 11 and a skirt portion 12 extending from an edge 11t of the lens portion 11. In other words, the edge 11t constitutes the joined portion between the lens portion 11 and the skirt portion 12. Also, the skirt portion 12 is formed extending from the edge 11t so as to have two plane faces in a direction intersecting the optical axis direction of the lens portion 11, and has a leg portion 13 surrounding a periphery of the skirt portion 12, so that the lens portion 11 can be optically adjusted easily and at high precision. The leg portion 13 is formed extending to the opposite side from the front side of the lens structure 10 (that is, to the rear side).

The lens structure 10 is formed by using a synthetic resin to integrally injection mold the lens portion 11 and the skirt portion 12. This injection molding can be carried out by injecting a synthetic resin such as an acrylic resin from a molding gate FG into a molding gate receiving portion 14. The molding gate receiving portion 14 is provided at an end of the skirt portion 12, and is configured to facilitate injection molding. In addition to an acrylic resin, the resin usable here can be a polycarbonate resin or the like.

The molding gate receiving portion 14 is similar to the skirt portion 12 in that it has two plane faces disposed parallel to a direction intersecting the optical axis direction of the lens portion 11. In other words, the molding gate receiving portion 14 can be formed at an end of the skirt portion 12 in the same manner as the skirt portion 12, which means that the structure of the mold used to form the molding gate receiving portion 14 can be simplified.

If the lens portion 11 has a small curvature and the lens diameter φ is large, then generally the thickness t2 of the edge 11t will be less, and as a result the thickness of the skirt portion 12 will also be less, and there will be greater resistance to the flow of the synthetic resin in injection molding.

According to this embodiment, however, since the molding gate receiving portion 14 is provided which has a thickness t3 that is greater than the thickness t2 of the edge 11t, it is possible to reduce resistance to the flow of the synthetic resin (molding resin) supplied from the molding gate FG (molding gate receiving portion 14) to the skirt portion 12 and the lens portion 11 during injection molding.

In other words, since a good flow of the molding resin to the skirt portion 12 and the lens portion 11 is ensured, and the resin will flow in more smoothly and stably, there is no loss of fluidity of the synthetic resin, the skirt portion and lens portion can be filled and molded smoothly and with good fluidity, stable lens portion 11 in which no sink marks or cracks occur can be formed at high precision, and stable injection molding can be performed at a high yield.

Because the thickness t2 of the edge 11t is less than the thickness t3 of the molding gate receiving portion 14, as mentioned above, it is possible to obtain a lens structure 10 having a lens portion 11 with a small curvature, a large lens diameter φ, and high precision. Also, the thickness t3 of the molding gate receiving portion 14 is designed to be less than the thickness t1 of the lens portion 11 in order to prevent the formation of sink marks on the lens portion 11. In other words, the relationship is such that the thickness t3 of the molding gate receiving portion 14<the thickness t1 of the lens portion 11.

When the lens diameter φ of the lens portion 11 was 10 mm, for example, and the thickness t1 of the lens portion 11 was from 3 to 5 mm, the thickness t3 of the molding gate receiving portion 14 could be set to about 2 to 3 mm, and the thickness t2 of the edge 11t could be set to 0.2 to 0.5 mm. When the thickness t2 of the edge 11t was less than 0.2 mm, there was more resistance to the resin flow and yield dropped off sharply. Accordingly, taking some extra yield into account, the thickness t2 of the edge 11t preferably is 0.3 to 0.5 mm.

It is undesirable for the thickness t2 of the edge 11t to be greater than 0.5 mm because this will hamper efforts at reducing the size of the lens structure 10. That is, by specifying the thickness t2 of the edge 11t, the desired lens structure 10 can be formed at a good yield and high precision.

The molding gate FG is disposed with respect to the molding gate receiving portion 14 so that its position is higher with respect to a plane as shown in cross section (FIG. 2), but may instead be disposed lower with respect to a plane. In either case, there is a reduction in resistance to the flow of synthetic resin in injection molding, so the synthetic resin can flow more smoothly and with better fluidity.

As mentioned above, a constitution which maintains the relationship: the thickness t2 of the edge 11t<the thickness t3 of the molding gate receiving portion 14<the thickness t1 of the lens portion 11 provides a lens portion 11 that has a smaller curvature, is thicker, and has a broader surface area, and short focus and high numerical aperture characteristics can be achieved. Also, because the lens structure 10 (lens portion 11) can be formed at high precision with fewer sink marks, cracks, and so forth, it is possible to form the lens portion 11 at high precision even when the lens portion 11 has an aspherical shape. Using an aspherical shape affords a compact and lightweight optical device 1 with no aberration.

FIG. 3 is a plan view of the back side of an optical device according to an embodiment of the present invention, in a state in which a lens structure is disposed in the housing of the optical device. FIG. 4 is a plan view of the rear face of a printed substrate inserted inside the housing of an optical device according to an embodiment of the present invention. FIG. 5 is a plan view of the back side of an optical device according to an embodiment of the present invention, in which a printed substrate is inserted inside the housing of the optical device.

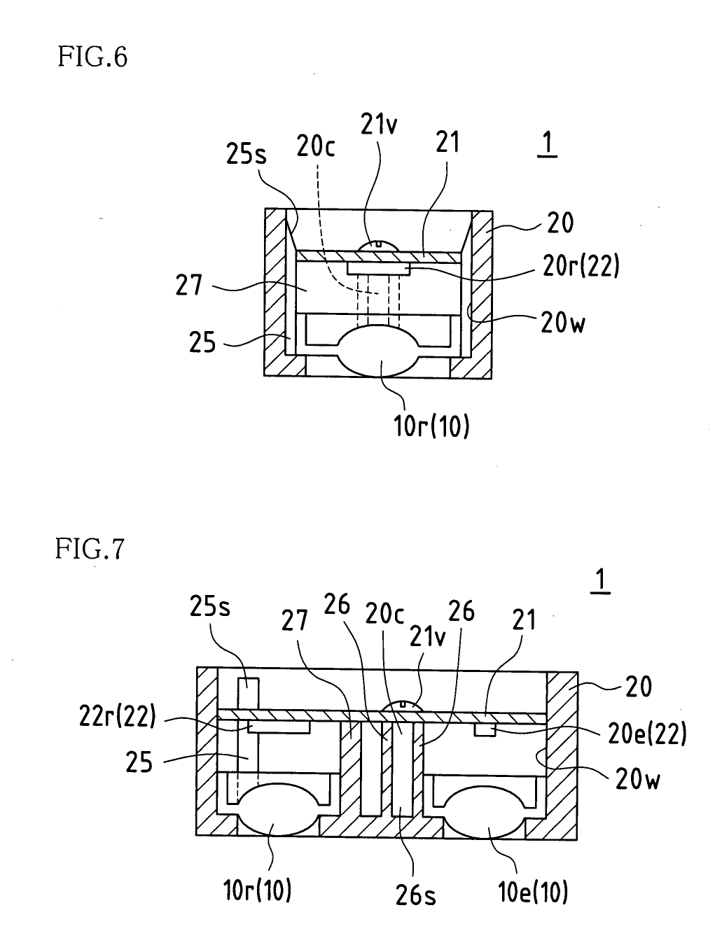

The optical device 1 is equipped with the lens structure 10 in a housing 20 that is open at the rear. The lens structure 10 is constituted, for example, by a light emission lens structure 10e and a light reception lens structure 10r (FIG. 3). In the following description, if there is no need to distinguish the light emission lens structure 10e from the light reception lens structure 10r, they will sometimes merely be referred to as the lens structure 10. The lens portion 11 is constituted to be exposed on the front side of the housing 20 (the far side in the drawings) (see FIGS. 6 and 7).

The lens structure 10 is shown as being separate from the housing 20, but the lens structure 10 and the housing 20 can be formed integrally by two-color molding, for example. Integral molding allows the assembly process of the optical device 1 to be simplified and its precision increased, and this affords a higher manufacturing yield and a reduction in manufacturing costs.

A printed substrate 21, in which a semiconductor light-emitting element 22e and a semiconductor light-receiving element 22r serving as optical semiconductor elements 22 are individually mounted, separate from one another, is inserted from the rear face of the housing 20, across from the lens structure 10. In other words, the semiconductor light-emitting element 22e and semiconductor light-receiving element 22r serving as the optical semiconductor elements are mounted on the surface of the printed substrate 21 (the side across from the lens structure 10) that is inserted inside the housing 20 (FIG. 4). In the following description, if there is no need to distinguish the semiconductor light-emitting element 22e from the semiconductor light-receiving element 22r, they will sometimes merely be referred to as the optical semiconductor elements 22.

A suitable wiring pattern is formed on the printed substrate 21, and the semiconductor light-emitting element 22e, the semiconductor light-receiving element 22r, and other circuit parts are suitably mounted as chip components. Also, the light emission lens structure 10e is disposed across from the semiconductor light-emitting element 22e, and the light reception lens structure 10r is disposed across from the semiconductor light-receiving element 22r.

A substrate fixing screw hole 21h, for inserting a screw that fixes the printed substrate 21 to the housing 20, is formed in the middle of the printed substrate 21. A substrate fixing column 20c into which is threaded the screw that fixes the printed substrate 21 to the housing 20 is erected (formed) in the middle of the inner bottom face of the housing 20. A screw hole 20h into which the screw is inserted is formed in the substrate fixing column 20c, corresponding to the substrate fixing screw hole 21h. This configuration makes it possible to screw and fix the printed substrate 21 to the housing 20 (the substrate fixing column 20c), and allows the optical semiconductor elements 22 and the lens structure 10 to be easily positioned and fixed across from each other.

The printed substrate 21 is configured so that it abuts a columnar anti-rotation portion 25 formed from the open side of an inner side face (inner wall 20w) of the housing 20 toward the inner bottom face (FIG. 5). This configuration effectively prevents the rotation of the printed substrate 21 caused by screwing it in place (rotation in the direction of the arrow Rot), makes it possible to position the optical semiconductor elements 22 and the lens structure 10 very precisely, and allows a high-precision optical device 1 to be obtained.

A plurality of the anti-rotation portions 25 are disposed at opposing locations on the inner wall 20w, such that they lie along the longitudinal side of the printed substrate 21, and are formed so as to protrude in the form of semicircular columns from the inner wall 20w. This configuration ensures enough space between the printed substrate 21 and the housing 20, so the printed substrate 21 can be inserted easily and reliably into the housing 20, which improves work efficiency. The anti-rotation portion 25 may have a suitably curvature, and does not need to have a true semicircular shape.

Also, even if the printed substrate 21 is larger than the specified size due to nominal error in the external dimensions, when the printed substrate 21 is inserted into the housing 20, the printed substrate 21 can be easily and precisely inserted in a state in which the anti-rotation portions 25 in the form of semicircular columns shave the edges of the printed substrate 21, so the space between the printed substrate 21 and the anti-rotation portions 25 can be made very small (minimized), ensuring accurately positioning precision.

The substrate fixing column 20c is supported by a plurality of reinforcing plates 26 (reinforcing plates 26a, 26b, 26c, and 26d; hereinafter, when there is no need to distinguish the reinforcing plates 26a, 26b, 26c, and 26d from one another, they will merely be referred to as the reinforcing plates 26). Using the plurality of reinforcing plates 26 ensures that the substrate fixing column 20c will be supported reliably and securely, with enough strength, and securely fixes the printed substrate 21. Therefore, an optical device 1 of high reliability can be obtained.

The reinforcing plates 26 are erected on the inner bottom face just as is the substrate fixing column 20c, and link and integrate the inner wall 20w and the substrate fixing column 20c together. If spaces are provided between the plurality of reinforcing plates 26 (between the reinforcing plate 26a and the reinforcing plate 26b, and between the reinforcing plate 26c and the reinforcing plate 26d) to create thinned portions 26s, it will be possible to obtain a housing 20 in which distortion does not occur by preventing the occurrence of sink marks in the molding resin around the middle of the housing 20 (around the substrate fixing column 20c and the reinforcing plates 26), so an optical device 1 can be obtained at a higher yield.

The reinforcing plates 26 are disposed between the semiconductor light-emitting element 22e and the semiconductor light-receiving element 22r. Therefore, it is possible to prevent the occurrence of an optical path by which light from the semiconductor light-emitting element 22e reaches the semiconductor light-receiving element 22r directly, without passing through the lens structure 10, and to block any other stray light, which enhances the optical characteristics of the optical device 1.

Also, a light blocking plate 27 is disposed, in addition to the reinforcing plates 26, between the semiconductor light-emitting element 22e and the semiconductor light-receiving element 22r. Therefore, stray light can be eliminated more effectively, and the optical characteristics of the optical device 1 can be further enhanced. It is also possible to provide additional reinforcing plates between the reinforcing plates 26 and the light blocking plate 27.

FIG. 6 is a cross section, viewed along the X-X line in FIG. 5, and FIG. 7 is a cross section, viewed along the Y-Y line in FIG. 5.

The lens structure 10 is inserted to the inner bottom face of the housing 20, with the skirt portion 12 abutting the inner wall 20w, and is positioned and fixed. The semiconductor light-emitting element 22e is correspondingly disposed at a lens structure 10e, and the semiconductor light-receiving element 22r is correspondingly disposed at a lens structure 10r. The printed substrate 21 is fixed by being fastened with a screw 21v to the substrate fixing column 20c.

Because the anti-rotation portion 25 has a slanted portion 25s at its end (the side where the printed substrate 21 is inserted), the insertion opening is larger when the printed substrate 21 is inserted, and the printed substrate 21 can be easily and reliably inserted into the housing 20, which makes the work easier.

By forming the anti-rotation portion 25, the reinforcing plates 26, and the light blocking plate 27 integrally with the housing 20 using a suitable synthetic resin, it is possible to simplify the manufacturing process and reduce the manufacturing cost (assembly cost).

As discussed above, the optical device 1 has short focus and high numerical aperture characteristics, so a more compact size and higher resolution can be achieved, allowing the optical device 1 to be applied to a range-finding device, for example. A case in which the optical device 1 is used as a range-finding device that operates by optical triangulation will be described.

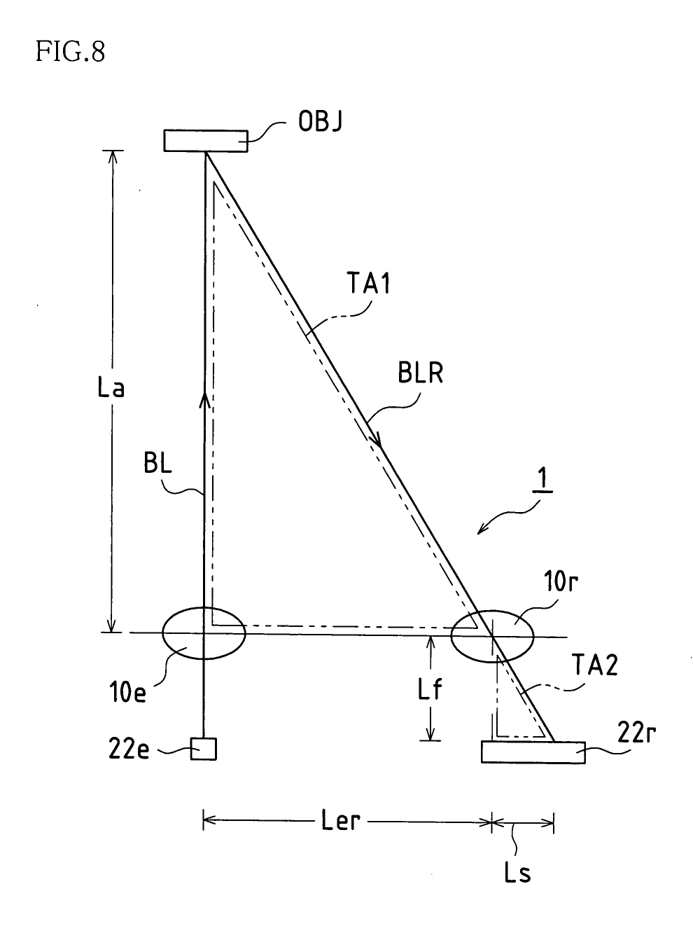

FIG. 8 is a diagram illustrating how an optical device according to an embodiment of the present invention is operated as a range-finding device to measure the distance to a ranging object.

For example, a light beam BL emitted from a semiconductor light-emitting element 22e made up of light emitting diodes (LEDs), for example, is converged on the light emission lens structure 10e (lens portion 11), and is irradiated to a ranging object OBJ. The light beam BL irradiated to the ranging object OBJ is diffused and reflected by the surface of the ranging object OBJ, then enters the light reception lens structure 10r (lens portion 11) as reflected light BLR, is converged, and an image is formed on a semiconductor light-receiving element 22r made up of position detection elements (PSDs).

A triangle TA1 made up of the light beam BL and the reflected light BLR on the outside of the optical device 1, and a triangle TA2 made up of the light reception lens structure 10r and the semiconductor light-receiving element 22r in the optical device 1 are similar.

Here, the lens spacing distance Ler between the light emission lens structure 10e and the light reception lens structure 10r, and the focal length Lf of the light reception lens structure 10r are determined by the structure of the optical device 1. Therefore, by measuring the displacement distance Ls of the light spot converged on the semiconductor light-receiving element 22r (the deviation from a reference position), it is possible to obtain a measured distance La from the optical device 1 to the ranging object OBJ.

That is, the measured distance La can be obtained as (focal length Lf lens spacing distance Ler/displacement distance Ls) from the relationship of (the measured distance La from the optical device 1 to the ranging object OBJ)/(the lens spacing distance Ler between the light emission lens structure 10e and the light reception lens structure 10r)=(the focal length Lf of the light reception lens structure 10r)/(the displacement distance Ls of the light spot converged on the semiconductor light-receiving element 22r).

Because of manufacturing limitations, short focus and high numerical aperture characteristics could not be attained in the lens structure 10. When the lens structure 10 according to this embodiment is applied to the optical device 1, however, the device can be made smaller, and an optical triangulation range-finding device capable of measuring long distances can be obtained. That is, by applying the optical device 1 according to this embodiment to an optical triangulation range-finding device, it is possible to provide a compact high performance range-finding device that can measure long distances.

Because it is possible to measure the distance to a screen by installing the above-mentioned range-finding device (optical device 1) as an electronic device such as a projector, a projector can be obtained that has higher functionality such as auto-focus and is more compact through more efficient use of space.

Also, by installing this in an electronic device such as a lighting device, it is possible to detect the distance to (position of) a person over a wide range of distances, and thereby control the lighting device to turn on/off. Also, by varying the brightness according to the distance to a person, an auto-switch sensor that is more compact and has higher functionality can be obtained.

Also, since it is possible to manufacture a short-focus lens, smaller size and higher functionality can be achieved not only in the above-mentioned range-finding devices, but also in precision photointerrupters and other such electronic devices.

The present invention can be embodied in a variety of other forms without departing from the main characteristics or essence thereof. Accordingly, the embodiments given above are in all respects nothing more than examples, and should not be interpreted to be limiting in nature. The scope of the present invention is as indicated by the Claims, and is in no way restricted to the text of this Specification. Furthermore, changes and modifications falling within an equivalent scope of the Claims are all within the scope of the present invention.

1. An optical device, comprising:
a lens structure in which a lens portion is injection molded integrally with a skirt portion extending from the edge of the lens portion; and
a housing that supports the lens structure,
wherein the skirt portion has a molding gate receiving portion corresponding to a molding gate for injection molding, and the thickness of the edge<the thickness of the molding gate receiving portion<the thickness of the lens portion is satisfied.

2. The optical device according to claim 1, wherein the thickness of the edge is about 0.2 to 0.5 mm.

3. The optical device according to claim 1, wherein the molding gate receiving portion has two plane faces disposed parallel to a direction intersecting the optical axis direction of the lens portion.

4. The optical device according to claim 2, wherein the molding gate receiving portion has two plane faces disposed parallel to a direction intersecting the optical axis direction of the lens portion.

5. The optical device according to claim 1, wherein the lens portion has an aspherical shape.

6. The optical device according to claim 1, wherein a printed substrate on which optical semiconductor elements are mounted is inserted in the housing and across from the lens structure, and the printed substrate is screwed to a substrate fixing column formed on the inner bottom face of the housing.

7. The optical device according to claim 6, wherein the printed substrate is configured so as to abut an anti-rotation portion formed on an inner side face of the housing.

8. The optical device according to claim 7, wherein the anti-rotation portion is in the form of a semicircular column.

9. The optical device according to claim 7, wherein the anti-rotation portion has a slanted portion for inserting the printed substrate.

10. The optical device according to claim 8, wherein the anti-rotation portion has a slanted portion for inserting the printed substrate.

11. The optical device according to any one of claims 6 to 10, wherein the substrate fixing column is supported by a plurality of reinforcing plates.

12. The optical device according to claim 1, wherein the lens structure and the housing are molded integrally.

13. The optical device according to claim 6, wherein the optical semiconductor elements are a semiconductor light-emitting element and a semiconductor light-receiving element mounted apart from each other on the printed substrate, and a light emission lens structure disposed across from the semiconductor light-emitting element and a light reception lens structure disposed across from the semiconductor light-receiving element are disposed as the lens structure.

14. The optical device according to claim 13, wherein the device is a range-finding device that measures the distance to a ranging object by irradiating the ranging object with the light from the semiconductor light-emitting element through the light emission lens structure, and receiving with the semiconductor light-receiving element the light reflected by the ranging object, through the light reception lens structure.

15. An electronic device in which an optical device is mounted, wherein the optical device is the optical device according to claim 1.
